(19) United States
(12) Patent Application Publication
(10) Pub. No.: US 2008/0228405 A1
(43) Pub. Date: Sep. 18, 2008

(54) Search Space Coverage With Dynamic Gene Distribution

(75) Inventors: Angel Janevski, New York, NY (US); J. David Schaffer, Wappingers Falls, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/997,601

(22) PCT Filed: Jul. 12, 2006
(86) PCT No.: PCT/IB06/52377

§ 371 Date: Feb. 1, 2008

Related U.S. Application Data
(60) Provisional application No. 60/706,119, filed on Aug. 5, 2005.

(51) Int. Cl. G06F 15/00

(52) U.S. Cl. 702/19

(57) ABSTRACT

A method and apparatus for selecting measurements from a plurality of measurements is disclosed. The method includes the steps of initializing a measurement status to a first value for each of the measurements, determining selectability of one of the plurality of measurements based on a corresponding status value, and updating the status to a second value after selecting the measurement. In one aspect of the invention, the step of determining selectability further comprises the step of selecting one of the plurality of measurements, and retaining the selected measurement when the value of the corresponding status is the first value.

This application relates to the field of search processes in genomics-based testing and, more specifically, to an improved method to include more measurements in the search process.

Subset selection problems are known to occur in a number of domains; for example, a pattern discovery for molecular diagnostics. In this domain, measurement data is typically available on patients with or without a specific disease and a desire to discover a subset of these measurements that can be used to reliably detect the disease. Evolutionary computation is one known method that can be used for determining a subset of measurements from the available measurements. Examples of evolutionary computations may be found in filed patent applications WO0199043 and WO0206829

Evolutionary search algorithms with some form of a subset selection have the property of taking into account a subset of the entire search space at a time. For example, a population of 100 chromosomes with 15 genes in each can only cover 1,500 distinct genes. If the search space contains more than 1,500 genes, it is not guaranteed, in general, that the algorithm will try out every gene at least once. The brute-force solution to this problem would be to increase the population size and/or the chromosome size, which is generally not practical as it adds a substantial computation burden to the algorithms.

U.S. Patent Application Ser. No. 60/639,747, entitled “Method for Generating Genomics-Based Medical Diagnostic Tests, filed on Dec. 28, 2004, the contents of which are incorporated by reference, herein, describes one method for determining a classifier for generating a first generation chromosome population of chromosomes, wherein each chromosome has a selected number of genes specifying a subset of an associated set of measurements. In this described method, the genes of the chromosomes are computationally genetically evolved to produce successive generation chromosome populations. The production of each successor generation chromosome population includes: generating offspring chromosomes from parent chromosomes of the present chromosome population by: (i) filling genes of the offspring chromosome with gene values common to both parent chromosomes and (ii) filling remaining genes with gene values that are unique to one or the other of the parent chromosomes; selectively mutating genes values of the offspring chromosomes that are unique to one or the other of the parent chromosomes without mutating gene values of the offspring chromosomes that are common to both parent chromosomes; and updating the chromosome population with offspring chromosomes based on the fitness of each chromosome determined using the subset of associated measurements specified by genes of that chromosome. A classifier is then selected that uses the subset of associated measurements specified by genes of a chromosome identified by the genetic evolution.

However, the method described employs a two-level hierarchical selection step, i.e., survival-of-the-fittest, designed to induce the evolution of accurate and small subsets. In this operation competing solutions, referred to as A and B, for the problem are compared as follows:

If (classification_errors (A)<classification_errors (B), then A is selected;

Or else, if (classification_errors (A)=classification_errors (B), and
(number_of_measurements(A)<number_of_measurements(B), then A is selected;

Otherwise, select A or B at random.
wherein classification_error( ) is a fitness measure.

Upon initialization, divergence and mutation genes are drawn from a pool of available genes randomly. An essential part of a genetic algorithm method is that there is occasional mutation during the mating of chromosomes. A gene of? a chromosome is mutated with a known probability to any gene number. In a special case, if duplicates are not allowed in chromosomes, the mutation is restricted only to genes not already present in the chromosome. On other occasions, where genes are randomly selected, the creation of the initial population and, after a divergence, most of the genes are picked randomly.

In the process described, the new genes are drawn with equal probability, i.e., 1/n, where n is the number of genes allowed to be part of the chromosome. This makes it possible that a good number of genes will not be explored as they may not be “drawn” for participation within a cycle of the evolutionary algorithm.

Hence, there is a need in the industry for a method that allows for inclusion or testing of all genes in the search process.

A method and apparatus for selecting measurements from a plurality of measurements is disclosed. The method includes the steps of initializing a measurement status to a first value for each of the measurements, determining selectability of one of the plurality of measurements based on a corresponding status value, and updating the status to a second value after selecting the measurement. In one aspect of the invention, the step of determining selectability further comprises the step of selecting one of the plurality of measurements, and retaining the selected measurement when the value of the corresponding status is the first value.

The invention may take form in various components and arrangements of components, and in various process operations and arrangements of process operations. The drawings are only for the purpose of illustrating preferred embodiments and are not to be construed as limiting the invention.

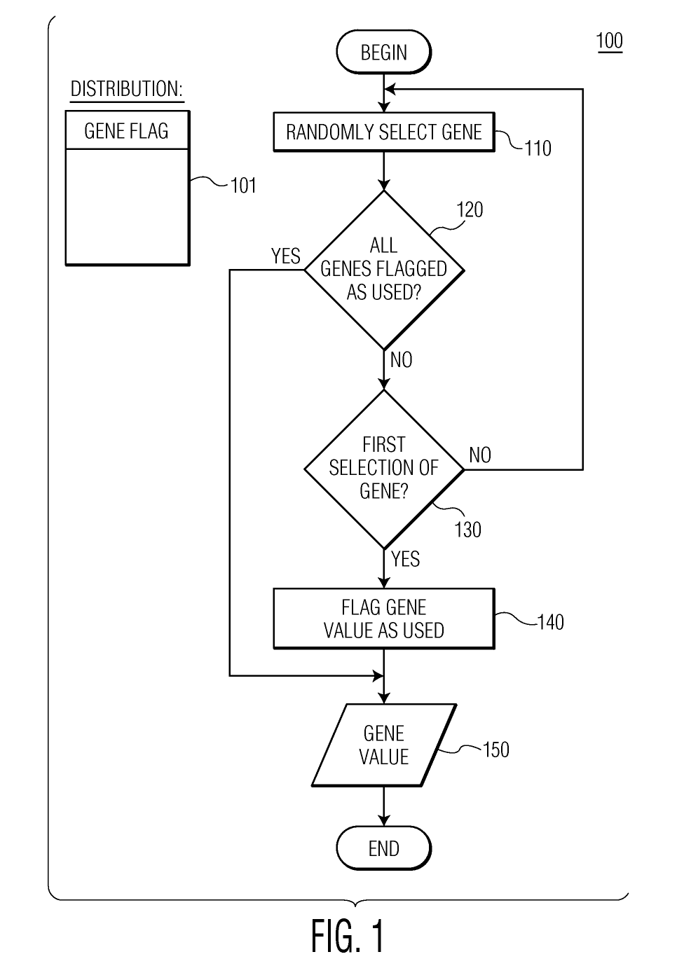

FIG. 1 illustrates an exemplary process for selecting genes in accordance with the first principle of the invention; and

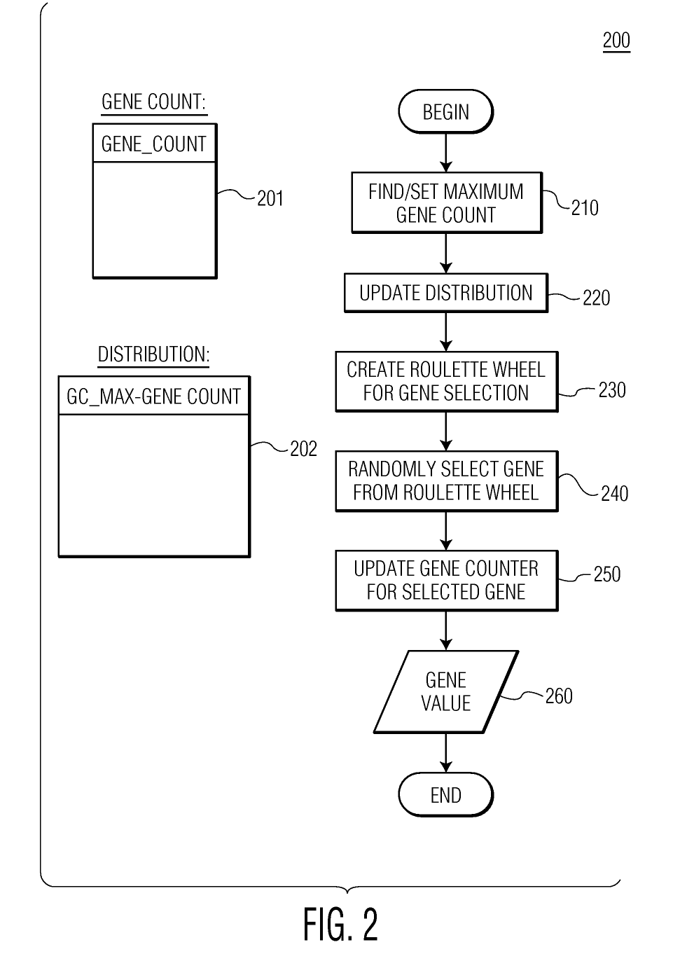

FIG. 2 illustrates a second exemplary process for selecting genes in accordance with the second principle of the invention.

It is to be understood that these drawings are for purposes of illustrating the concepts of the invention and are not drawn to scale. It will be appreciated that the same reference numerals, possibly supplemented with reference characters where appropriate, have been used throughout to identify corresponding parts.

Selecting genes may be performed as described in the aforementioned commonly-owned U.S. patent application. However, as is described therein, the selection of genes is limited as not all genes may be examined.

In accordance with one—and a preferred—principle of the invention, a vector, referred to as gene_count, of size N is maintained, which includes a counter for each of the N genes, i.e., measurements, in the space and the counter is incremented each time a gene or measurement is found in a chromosome. Further in accordance with the principles of the invention, a vector, referred to as distribution, is provided, which determines how mutated genes are selected.

Gene_count is initialized to a known value, preferably, a zero (0) value and values in vector distribution are initialized to a second known value, preferably, a one (1) value. Each time a gene_count counter at position i is incremented, the value at corresponding position i in the vector distribution may be updated. In one aspect of the invention, which is more fully described in the example shown in process 100 of FIG. 1, the associated distribution value is set to zero (0).

In accordance with the principles of the invention, when a gene is randomly selected, the algorithm limits the use of the randomly selected genes to those genes for which the corresponding value in vector gene_counter is one (1), or more generally, the algorithm limits or diminishes the probability that a frequently-used gene is reused before a less-frequently used one. When all values in vector distribution are set to indicate that they have been processed, e.g., a zero (0) value, a flag, referred to as restore_distribution, is set to a “True” value and selection of genes as described in the above referenced commonly-owned U.S. patent application is resumed.

FIG. 1 illustrates a flow chart of an exemplary process 100 in accordance with the first principle of the invention. In this exemplary process, a single data structure—the vector distribution (101) is used and is initialized to ‘not flagged,’ i.e., zero (0) value. In this exemplary process, a gene is selected randomly at block 110. In case all genes have already been selected (block 120: all values in distribution flagged to 1), then accept the gene and output it in block 150. Otherwise, if all genes have not been used and this gene is flagged as used at block 130, then repeat the gene selection process at block 110. If the selected gene has not been used, (i.e., an affirmative decision at block 130), then flag the gene as used (at block 140) and is output at block 150.

While the process 100 guarantees that all gene values are randomly selected at least once (as long as there are as many selections as the number of possible gene values), it is very restricting and does not ensure that all gene values are equally selected throughout the search.

FIG. 2 illustrates a flow chart of an exemplary process 200 in accordance with a second principle of the invention. This process provides a distribution that is dynamically adjusted for a length of time, up to the entire execution of the experiment. In this aspect of the invention, two data structures are used in this process: gene_count (201) wherein for each gene, an associated counter is increased every time the gene is selected; and distribution (202) which contains values associated with each gene based on the values in gene_count, and optionally a preset maximum value. All fields in distribution are initialized to a second known value, e.g., one (1).

In process 200, the selection begins with setting the maximum gene count (max-GC) to a predetermined value, or, for example, to the maximum number in the gene_count data structure (201), which is done in block 210. The second aspect of the invention is advantageous as it assures that vector distribution is dynamically updated throughout the experiment.

In this case, the values in vector distribution are updated with the following principle: if the value in gene_count is smaller than max-GC, the value in distribution is set to max-GC—gene_count. Otherwise, If not smaller than max-GC, the value in distribution is set to zero (0). Note that when max-GC is set by the maximum value in gene_count, it is never set to zero (0) by the later rule in step 220. A practical way to select a value based on distribution is by the well-known Roulette Wheel Selection Rule. For this, a list of genes is created with a length equal to the sum of all values in distribution. Then, each gene number is repeated in the list exactly as many times as the value in distribution (230). This forms the “roulette” of which one value is randomly selected (240). The gene-counter for the selected gene is incremented (250) and the value is returned (260).

The processes in FIG. 1 and FIG. 2 may be used for replacement for the random pickup of a value in the process as described in the above referenced commonly owned U.S. patent application.

It is also considered in the scope of the invention that the invention is not limited to the algorithm described in the above referenced commonly-owned U.S. patent application (named CHC), but may be used with any genetic algorithm (GA) implementation. The method described herein is further advantageous as it relies on the safety mechanisms in CHC that ensure that common gene values are preserved, and allows for other methods for randomized gene selection to be used. In general, this algorithm can be used with any method where adequate coverage of the feature space is required.

A system according to the invention can be embodied as hardware, a programmable processing or computer system that may be embedded in one or more hardware/software devices, loaded with appropriate software or executable code. The system can be realized by means of a computer program. The computer program will, when loaded into a programmable device, cause a processor in the device to execute the method according to the invention. Thus, the computer program enables a programmable device to function as the system according to the invention.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention.

It is expressly intended that all combinations of those elements that perform substantially the same function in substantially the same way to achieve the same results are within the scope of the invention. Substitutions of elements from one described embodiment to another are also fully intended and contemplated.

1. A method for selecting measurements from a plurality of measurements comprising the steps of:
initializing a measurement status (101) to a first value for each of the measurements;
determining selectability of one of the plurality of measurements based on a corresponding status value (120, 130); and
updating the status to a second value after selecting the measurement (140).

2. The method as recited in claim 1, wherein the step of determining selectability further comprises the step of:
selecting one of the plurality of measurements (110); and
retaining the selected measurement when the value of the corresponding status is the first value (130).

3. The method as recited in claim 2, wherein the step of selecting one of the plurality of measurements comprises the step of:
randomly selecting one of the plurality of measurements (110).

4. The method as recited in claim 2, wherein the step of selecting one of the plurality of measurements comprises the step of:
generating a roulette wheel selection process (240).

5. The method as recited in claim 1, further comprising the step of:
initializing a distribution value for each of the plurality of measurements (202); and
updating the distribution value when a corresponding measurement is selected (220).

6. An apparatus for selecting measurements from a plurality of measurements comprising:
a computer system for executing a code for:
initializing a measurement status (101) to a first value for each of the measurements;
determining selectability of one of the plurality of measurements based on a corresponding status value (120, 130); and
updating the status to a second value after selecting the measurement (140).

7. The apparatus as recited in claim 6, wherein the computer system determines selectability by executing a code for:
selecting one of the plurality of measurements (110); and
retaining the selected measurement when the value of the corresponding status is the first value (130).

8. The apparatus as recited in claim 7, wherein the computer system selects one of the plurality of measurements by executing a code for:
randomly selecting one of the plurality of measurements (110).

9. The apparatus as recited in claim 7, wherein the computer system selects one of the plurality of measurements by executing a code for:
generating a roulette wheel selection process (240).

10. The apparatus as recited in claim 6, wherein the computer system further executes a code for:
initializing a distribution value for each of the plurality of measurements (202); and
updating the distribution value when a corresponding measurement is selected (220).

11. A compute software product containing a code for instructing a computer for selecting measurements from a plurality of measurements the code instructing the computer to execute the steps of:
initializing a measurement status (101) to a first value for each of the measurements;
determining selectability of one of the plurality of measurements based on a corresponding status value (120, 130); and
updating the status to a second value after selecting the measurement (140).

12. The computer software product as recited in claim 11, wherein the code further instructs the computer to execute the steps of:
selecting one of the plurality of measurements (110); and
retaining the selected measurement when the value of the corresponding status is the first value (130).

13. The computer software product as recited in claim 12, wherein the code further instructs the computer to select one of the plurality of measurements by executing the step of:
randomly selecting one of the plurality of measurements (110).

14. The computer software product as recited in claim 12, wherein the code further instructs the computer to select one of the plurality of measurements by executing the step of:
generating a roulette wheel selection process (240).

15. The computer software product as recited in claim 11, further comprising the step of:
initializing a distribution value for each of the plurality of measurements (202); and
updating the distribution value when a corresponding measurement is selected (220).
